(19) United States
(12) Patent Application Publication
(10) Pub. No.: US 2013/0330655 A1
(43) Pub. Date: Dec. 12, 2013

(54) Sulfonated PPS Fuel Cell Electrode

(71) Applicants: James Mitchell, Bloomfield, NY (US); Timothy J. Fuller, Pittsford, NY (US); Ted Gacek, Camillus, NY (US)

(72) Inventors: James Mitchell, Bloomfield, NY (US); Timothy J. Fuller, Pittsford, NY (US); Ted Gacek, Camillus, NY (US)

(73) Assignee: GM GLOBAL TECHNOLOGY OPERATIONS LLC, Detroit, MI (US)

(21) Appl. No.: 13/492,310

(22) Filed: Jun. 8, 2012

(51) Int. Cl. H01B 1/22; H01M 8/04; H01B 1/24; B82Y 30/00

(52) U.S. Cl. 429/514; 252/514; 252/511; 977/700

(57) ABSTRACT

A method for making a fibrous layer for fuel cell applications includes a step of combining a polyphenylene sulfide-containing resin with a water soluble carrier resin to form a resinous mixture. The resinous mixture is then shaped to form a shaped resinous mixture. The shaped resinous mixture includes polyphenylene sulfide-containing structures within the carrier resin. The shaped resinous mixture is contacted (i.e., washed) with water to separate the polyphenylene sulfide-containing structures from the carrier resin. Optional protogenic groups and then a catalyst are added to the polyphenylene sulfide-containing structures.

The present invention relates to modified polyphenylene sulfide (PPS) fibers that are useful in fuel cell applications.

### BACKGROUND OF THE INVENTION

High quality porous pads are used for filtration and in a number of electronic devices such as batteries and fuel cells. In such devices, the porous pads advantageously allow gases or components dissolved in liquids to pass through. Porous pads are made of micro-fibers, nanofibers, and micro-porous films. Fibers of these dimensions are prepared by electrospinning in the case of solvent soluble polymers. However, polyolefins are difficult to form solutions without maintaining high temperatures in high-boiling solvents. Porous polyolefins are made by biaxial tension on films or sheets of these plastic polymers. Alternatively, pore formers are added to the polyolefin sheets during the fabrication process which are then extracted by solvents or removed with heat. Electrospinning can be used in the case of solvent soluble olefins which can be processed in solutions.

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). Proton exchange membrane (“PEM”) fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Typically, the ion conductive polymer membrane includes a perfluorosulfonic acid (PFSA) ionomer.

Each catalyst layer has finely divided catalyst particles (for example, platinum particles), supported on carbon particles, to promote oxidation of hydrogen at the anode, and reduction of oxygen at the cathode. Protons flow from the anode through the ion conductive polymer membrane to the cathode where they combine with oxygen to form water which is discharged from the cell.

The MEA is sandwiched between a pair of porous gas diffusion layers (“GDL”), which in turn are sandwiched between a pair of electrically conductive flow field elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

In many fuel cell applications, electrode layers are formed from ink compositions that include a precious metal and a perfluorosulfonic acid polymer (PFSA). For example, PFSA is typically added to the Pt/C catalyst ink in electrode layer fabrication of proton exchange membrane fuel cells to provide proton conduction to the dispersed Pt nanoparticle catalyst as well as binding of the porous carbon network. Traditional fuel cell catalysts combine carbon black with platinum deposits on the surface of the carbon, along with ionomers. The carbon black provides (in part) a high surface area conductive substrate. The platinum deposits provide a catalytic behavior, and the ionomers provide a proton conductive component. The electrode is formed from an ink that contains the carbon black catalyst and the ionomer, which combine on drying to form an electrode layer.

Gas diffusion layers have a multidimensional role in fuel cell technology. For example, gas diffusion layers act as diffusers for reactant gases traveling to the anode and the cathode layers while transporting product water to the flow field. Gas diffusion layers also conduct electrons and transfer heat generated at the membrane electrode assembly to the coolant, and acts as a buffer layer between the soft membrane electrode assembly and the stiff bipolar plates. Although the present technologies for making gas diffusion layers for fuel cell applications work reasonably well, improvement in properties and cost are still desirable.

Accordingly, the present invention provides improved methods of making porous pads that are useful in fuel cell applications.

### SUMMARY OF THE INVENTION

The present invention solves one or more problems of the prior art by providing in at least one embodiment a method of making a fibrous layer for fuel cell applications. The method includes a step combining a polyphenylene sulfide-containing resin with a water soluble carrier resin to form a resinous mixture. The resinous mixture is then extruded to form a shaped resinous mixture. The shaped resinous mixture includes polyphenylene sulfide-containing structures within the carrier resin. The shaped resinous mixture is contacted (i.e., washed) with water to separate the polyphenylene sulfide-containing structures from the carrier resin. Optional protogenic groups and then a catalyst are added to the polyphenylene sulfide-containing structures.

In another embodiment, a method of making a fibrous sheet for fuel cell applications is provided. The method includes a step of combining a polyphenylene sulfide-containing resin with a water soluble carrier resin to form a resinous mixture. The resinous mixture is extruded to form an extruded resinous mixture. The extruded resinous mixture includes polyphenylene sulfide-containing fibers disposed within the carrier resin. The extruded resinous mixture is contacted with water to separate the polyphenylene sulfide-containing fibers from the carrier resin. The polyphenylene sulfide-containing fibers are then optionally sulfonated to form sulfonated polyphenylene sulfide-containing fibers. At least a portion of the polyphenylene sulfide-containing fibers are coated with a catalyst. The sulfonated polyphenylene sulfide-containing fibers are then formed into a fuel cell electrode layer.

In still another embodiment, a fuel cell including sulfonated polyphene sulfide-containing fibers is provided. The fuel cell includes a first flow field plate and a second flow field plate. A first catalyst-containing electrode layer and second catalyst-containing electrode layer is interposed between the first flow field plate and the second flow field plate. An ion-conducting layer is interposed between the first catalyst layer and the second catalyst layer. Characteristically, at least one of the first catalyst-containing electrode layer and the second catalyst-containing electrode layer includes sulfonated polyphenylene sulfide-containing fibers which include catalyst.

The nanometer scale sulfonated polyphenylene sulfide fibers of various embodiments can be modified to have ionomeric behavior, catalytic behavior, and electrically conductive properties. These modifications provide part or all of the properties of traditional carbon black-platinum fuel cell catalysts, into a single component. The outer dimension of the fibers is also in the range of the outer dimension of carbon black particles used in carbon black-platinum fuel cell catalysts, creating surface areas similar in range to the functional surface of the carbon black catalysts.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating a separator;

FIG. 2 is an idealized top view of a fibrous plate or pad made by a variation of the method set forth below;

FIG. 3 is a schematic flow chart showing the fabrication of a polyphenylene sulfide fibers for fuel cell applications;

FIGS. 4A and 4B provide a micrograph of poly(phenylene sulfide) nanofibers at two different magnifications;

FIGS. 5A and 5B are micrographs of sulfonated poly(phenylene sulfide) at two different magnifications;

FIGS. 6A and 6B provide micrographs of platinum metalized poly(phenylene sulfide) nanofibers at two different magnifications; and

FIGS. 7A and 7B provide micrographs of gold-palladium metalized poly(phenylene sulfide) nanofibers at two different magnifications.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

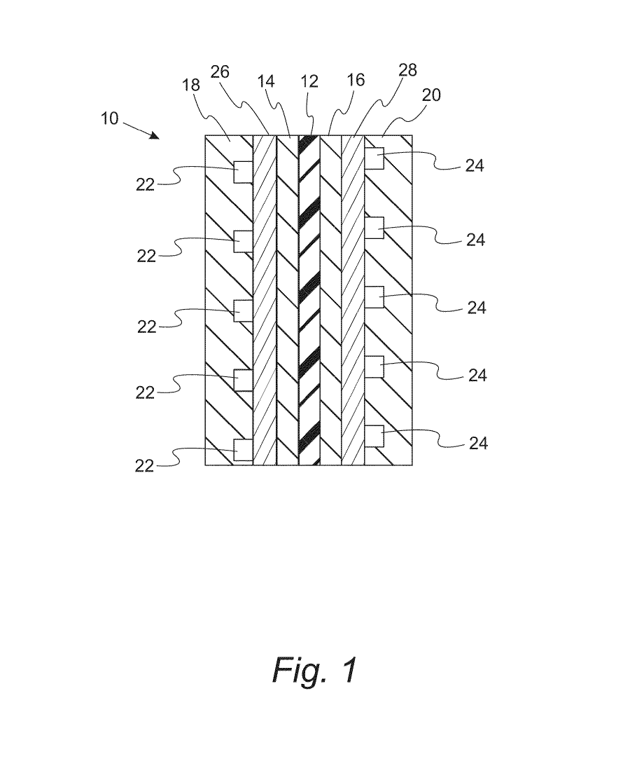

With reference to FIG. 1, a schematic cross section of a fuel cell that incorporates an embodiment of a fibrous sheet is provided. Proton exchange membrane (PEM) fuel cell 10 includes polymeric ion conducting membrane 12 disposed between cathode catalyst layer 14 and anode catalyst layer 16. Fuel cell 10 also includes flow field plates 18, 20, gas channels 22 and 24, and gas diffusion layers 26 and 28. Advantageously, cathode catalyst layer 14 and/or anode catalyst layer 16 include polyphenylsulfide (PPS) structures (i.e., fibers) as set forth below. During operation of the fuel cell, a fuel such as hydrogen is feed to the flow field plate 20 on the anode side and an oxidant such as oxygen is feed flow field plate 18 on the cathode side. Hydrogen ions are generated by anode catalyst layer 16 migrate through polymeric ion conducting membrane 12 were they react at cathode catalyst layer 14 to form water. This electrochemical process generates an electric current through a load connect to flow field plates 18 and 20.

In embodiments of the present invention, polyphenylene sulfide nanometer thick fibers are functionalized with the addition of sulfonic acid groups, producing a proton conductive fiber. These fibers can be added to an electrode layer as a reinforcing component. They offer a number of advantages over other additives. In particular, polyphenylene sulfide is resistant to heat, acids and alkalies, bleaches, aging, sunlight, and abrasion. The fibers readily disperse into water and alcohols, and with the addition of sulfonic acid groups, are an excellent option as an electrode additive. The flexible nature of the fiber reduces concerns common with more ridged fibers. In general, polyphenylene sulfide is difficult to modify chemically since this material does not dissolve in any solvent except at high temperatures, and is broadly non-reactive. The processes of the present invention are surprisingly discovered to produce nanometer thick fibers which are modifiable with protogenic groups and, in particular, sulfonic acid groups. The nanometer thickness of the PPS fibers and their strong tendency to entangle are unique, in comparison to fibers produced from other thermoplastics. This feature combined with a high operating temperature make PPS uniquely suitable as an electrode additive. In some variations, the fibers can also have fiber diameters in the micron range. In particular, fibers from about 10 to about 30 microns are produced.

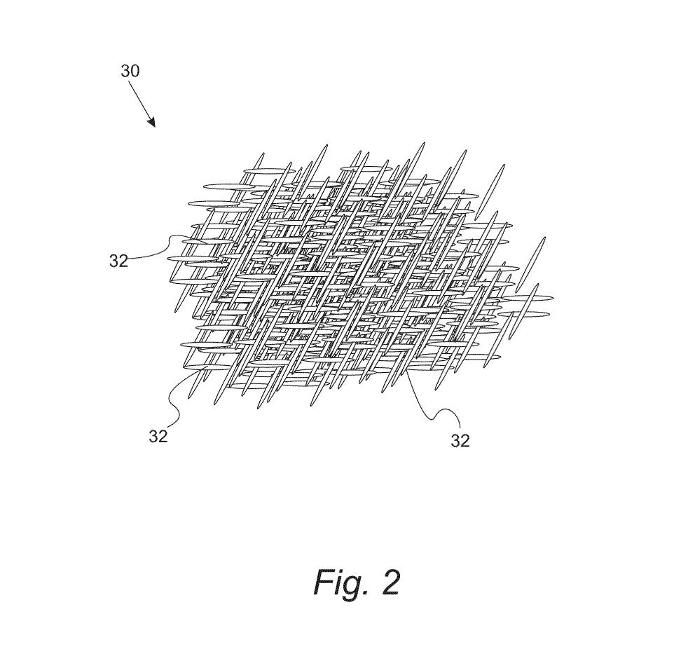

With reference to FIG. 2, an idealized top view of a fibrous pad made by a variation of the method set forth below is provided. Fibrous sheet 30 is formed from a plurality of polyphenylene sulfide fibers 32 aggregated together to form a pad-like layer. Typically, polyphenylene sulfide fibers 32 have an average width from about 5 nanometers to about 30 microns. In another refinement, polyphenylene sulfide fibers 32 have an average width (i.e., diameter) from about 5 nanometers to about 10 microns. In still another refinement, polyphenylene sulfide fibers 32 have an average width of from about 10 nanometers to about 5 microns. In still another refinement, polyphenylene sulfide fibers 32 have an average width of from about 100 nanometers to about 5 microns. In still another variation, polyphenylene sulfide fibers 32 have an average width of from about 50 nanometers to about 400 nm. In yet another refinement, fibrous sheet 30 is electrically conductive. In certain variations, polyphenylene sulfide fibers 32 are modified with protogenic groups and/or metal layers as set forth below.

In a variation of the present embodiment, fibrous sheet 30 has a thickness from about 50 microns to about 2 mm. In a refinement, fibrous sheet 30 has a thickness from about 50 microns to about 1 mm. In another refinement, fibrous sheet 30 has a thickness from about 100 microns to about 500 mm.

In another variation, the fibrous sheet includes voids that result in porosity. In a refinement, the porosity is from about 5 to 95 volume percent. In this context, porosity means the volume percent of the sheet that is empty. In another refinement, the porosity is from about 20 to 80 volume percent. In still another refinement, the porosity is from about 40 to 60 volume percent.

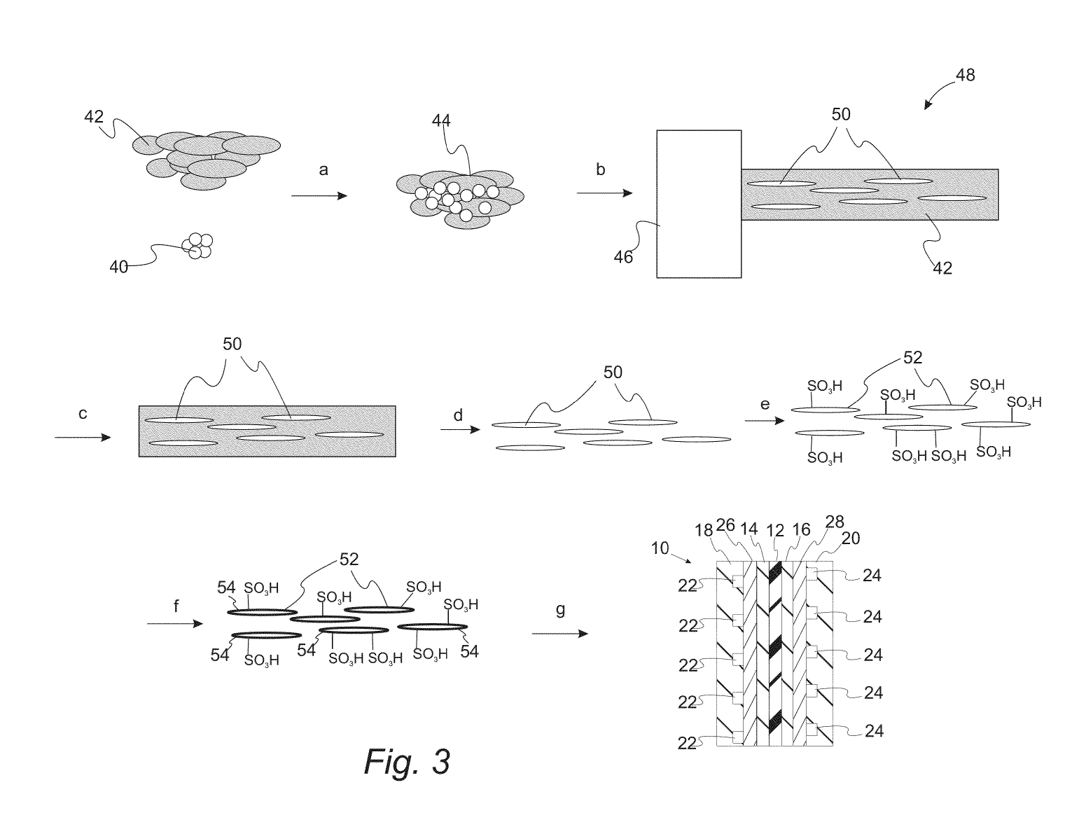

With reference to FIG. 3, a schematic flow chart illustrating a method of making polyphenylene sulfide structures useful for fuel cell applications is provided. In step a), polyphenylene sulfide-containing resin 40 is combined with water soluble carrier resin 42 to form resinous mixture 44. In a refinement, the weight ratio of polyphenylene sulfide-containing resin 40 to water soluble carrier resin 42 is 1:100 to about 10:1 In another refinement, the weight ratio of polyphenylene sulfide-containing resin 40 to water soluble carrier resin 42 is 1:50 to about 10:1 In still another refinement, the weight ratio of polyphenylene sulfide-containing resin 40 to water soluble carrier resin 42 is 1:10 to about 10:1 In step b), resinous mixture 44 is shaped. FIG. 3 depicts a particular example in which resinous mixture 44 is extruded. Therefore, resinous mixture 44 is extruded from extruder 46 in step b) to form extruded resinous mixture 48. Extruded resinous mixture 48 includes polyphenylene sulfide-containing fibers 50 within carrier resin 42. In a refinement, the extrusion can be varied or replaced with a step to produce bead, spheres or oblong polyphenylene sulfide-containing structures. The formation of beads, spheres, or oblong shapes depend on the extrusion conditions. If beads are desired, the melted extruded material (molten extrudate) should not be pulled under tension and stretched to deform the incompatible spherical domains into fibers. In step c), the extruded fiber is optionally separated from extruder 46. In step d), polyphenylene sulfide-containing fibers 50 are freed from the fiber by contacting/washing in water. In step e), protogenic groups (PG) are optionally added to the polyphenylene sulfide-containing fibers to form modified polyphenylene sulfide-containing fibers 52:

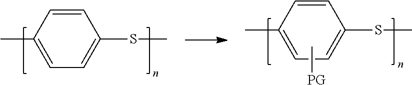

wherein PG is —SO₂X, —PO₃H₂, and —COX where X is an —OH, a halogen, or an ester and n is a number from about 20 to about 500 on average. In particular, the polyphenylene sulfide-containing fibers are sulfonated (SO₃H) in this step.

In a variation, the polyphenylene sulfide containing fibers are at least partially coated with a metal-containing layer 54 in step f). In a refinement, metal-containing layer 54 is a catalyst-containing layer. In a refinement, metal-containing layer 54 comprises a component selected from the group consisting of gold, palladium, platinum, and combinations thereof. Suitable film coating processes for forming the catalyst-containing layer include, but are not limited to, physical vapor deposition (PVD), plasma enhanced chemical vapor deposition (PECVD), magnetron sputtering, electron beam deposition, ion beam enhanced deposition, ion assisted deposition, chemical vapor deposition, electroplating, and the like.

In step g), polyphenylene sulfide-containing fibers 50 or modified polyphenylene sulfide-containing fibers 52 are formed into or incorporated into a fuel cell component, e.g., catalyst-containing electrode layers such as cathode catalyst layer 14 and/or anode catalyst layer 16. In a refinement, the catalyst-containing electrode layers are formed by pressing and heating of sulfonated polyphenylene sulfide-containing fibers 52. In another refinement, sulfonated polyphenylene sulfide-containing fibers 52 are bonded to paper or a mat. In another refinement, sulfonated polyphenylene sulfide-containing fibers 52 are combined with a solvent and an optional ionomer (e.g., Nafion™—a perfluorosulfonic acid polymer). This ink composition is applied to a surface (e.g., an ion conducting layer or a gas diffusion layer) in a fuel cell component, and then dried. In this latter refinement, suitable solvents include alcohols (e.g., methanol, alcohol, propanol, and the like) and water. A combination of alcohol and water is found to be particularly useful. Typically, a cathode catalyst layer 14 and/or anode catalyst layer 16 formed by this method has a thickness from about 5 microns to 5 mm. For optimal performance, cathode catalyst layer 14 and/or anode catalyst layer 16 are electrically conductive.

In a refinement of the present invention, polyphenylene sulfide-containing resin 40 used in step a) includes a plurality of electrically conductive particles. Examples of useful electrically conductive particles include, but are not limited to, carbon particles, graphite particles, metal particles, and combinations thereof. In another refinement, polyphenylene sulfide-containing resin 40 used in step a) further includes another thermoplastic resin. Examples of suitable thermoplastic resins include, but are not limited to, polyolefins, polyesters, and combinations thereof. Other examples include, but are not limited to, polyethylene, polypropylene, polybutene, polybutylene terephthalate, perfluorosulfonic acid polymers, perfluorocyclobutane polymers, polycycloolefins, polyperfluorocyclobutanes, polyamides (not water soluable), polylactides, acrylonitrile butadiene styrene, acrylic, ethylene-vinyl acetate, ethylene vinyl alcohol, fluoropolymers (e.g., PTFE, FEP, etc), polyacrylates, polyacrylonitrile (e.g., PAN), polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyetherketone, polyetherimide, polyethersulfone, polyethylenechlorinates, polymethylpentene, polyphenylene oxide, polystyrene, polysulfone, polytrimethylene terephthalate, polyurethane, polyvinyl acetate, polyvinyl chloride, polyvinylidene chloride, styrene-acrylonitrile, and combinations thereof. Examples of suitable water-soluble resins include, but are not limited to, water-soluble polyamides (e.g., poly(2-ethyl-2-oxazoline) (“PEOX”). In a refinement, the PEOX has a number average molecular weight from about 40,000 to about 600,000. Molecular weights of 200,000 and 500,000 have been found to be particularly useful.

In a refinement of the present invention for the variations and embodiments set forth above, the fibers have an average cross sectional width (i.e., diameter when the fibers have a circular cross section) from about 5 nanometers to about 30 microns. In another refinement, the fibers have an average width of about 5 nanometers to about 10 microns. In still another refinement, the fibers have an average width of from about 10 nanometers to about 5 microns. In still another refinement, the fibers have an average width of from about 100 nanometers to about 5 microns. The length of the fibers typically exceeds the width. In a further refinement, the fibers produced by the process of the present embodiment have an average length from about 1 mm to about 20 mm or more.

The following examples illustrate the various embodiments of the present invention. Those skilled in the art will recognize many variations that are within the spirit of the present invention and scope of the claims.

Polyphenylene sulfide (PPS) thermoplastic fibers are first created by dispersing PPS in 500,000 MW water soluble polymer poly(2-ethyl-2-oxazoline) (PEOX). Specifically, 5 grams of PPS is first blended in a Waring blender with 15 grams of 500,000 MW PEOX (a ratio of 1 to 3). The combined blend is added to a laboratory mixing extruder (Dynisco, LME) operated at 240° C. header and rotor temperatures with the drive motor operated at 50% of capacity, resulting in an extruded strand of the blend. This extruded strand is added to the blender to return it to granular form, and re-extruded two more times, creating a uniform extruded strand. During the final extrusion processes, the fibers are spun onto a take-up wheel (a Dynisco Take-Up System (TUS), at approximately 10 cm/second.

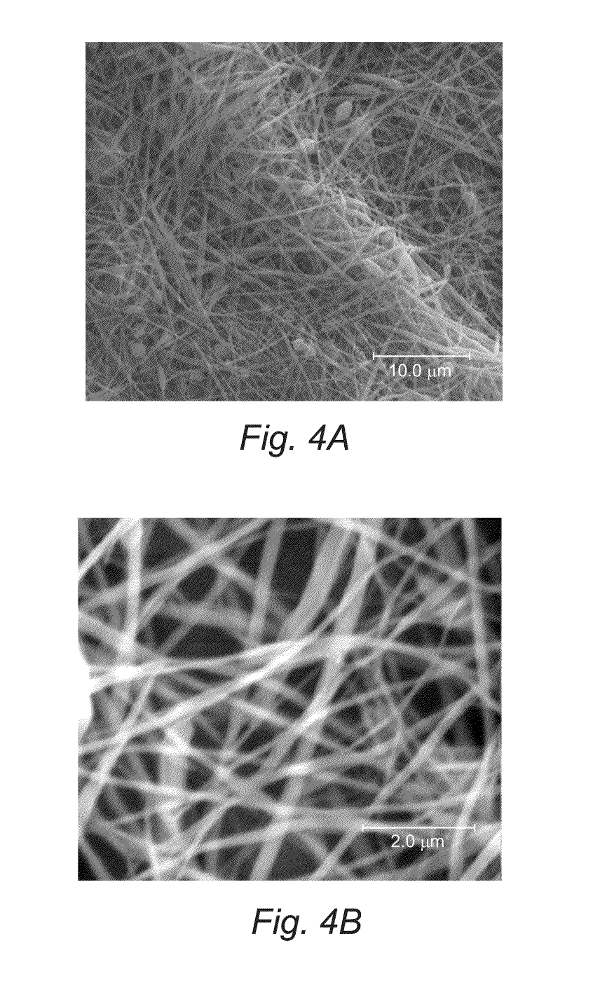

The resulting extruded strand is washed in deionized, reverse osmosis (RO water with repeated rinses, until the PEOX has been removed, resulting in a sample of PPS nanofibers. The fibers are then rinsed in isopropyl alcohol and allowed to dry completely overnight. FIGS. 4A and 4B provide a micrograph of poly(phenylene sulfide) nanofibers at two different magnifications.

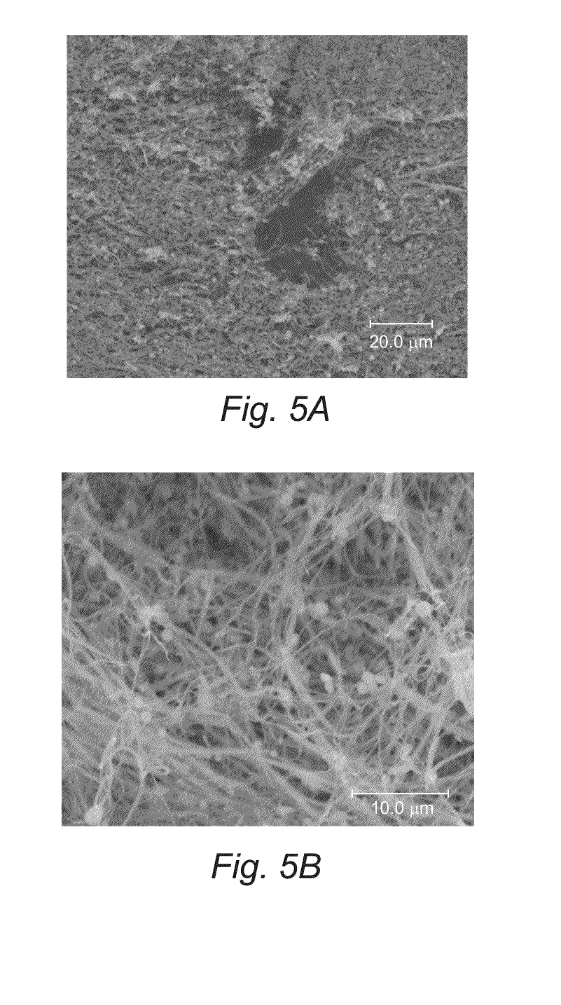

The poly(phenylene sulfide) nanofibers are sulfonated in a way that does not reduce the high surface area form of the PPS back to a sheet form. Nanofibers of poly(phenylene sulfide) (2 g, Example 1) are suspended in methylene chloride (50 g) in a screw-cap jar with a Teflon gasketed lid. Chlorosulfonic acid is first dispersed in methylene chloride (1 gram in approximately 10 g). With vigorous stirring, chlorosulfonic acid dispersion (1 g of acid) is added to the dispensation of PPS fibers in methylene chloride and the lid is secured. The jar is roll-milled for 4 hours and then the dark green-blue fibrous mixture is added to water (1 L) and is stirred for 16 hours. The sulfonated fibers are washed extensively with water and filtered onto a polypropylene mat (SeFar America). The ion exchange capacity of the fibers is 1.03 meq H⁺/g. The reaction is repeated using two grams of chlorosulfonic acid and two grams of nanofibers of poly(phenylene sulfide). The ion exchange capacity of the resultant fibers is 1.3 meq H⁺/g. The resulting fibers of poly(phenylene sulfide) with sulfonic acid groups is referred to as PPS-S fibers. FIGS. 5A and 5B are micrographs of sulfonated poly(phenylene sulfide) at two different magnifications.

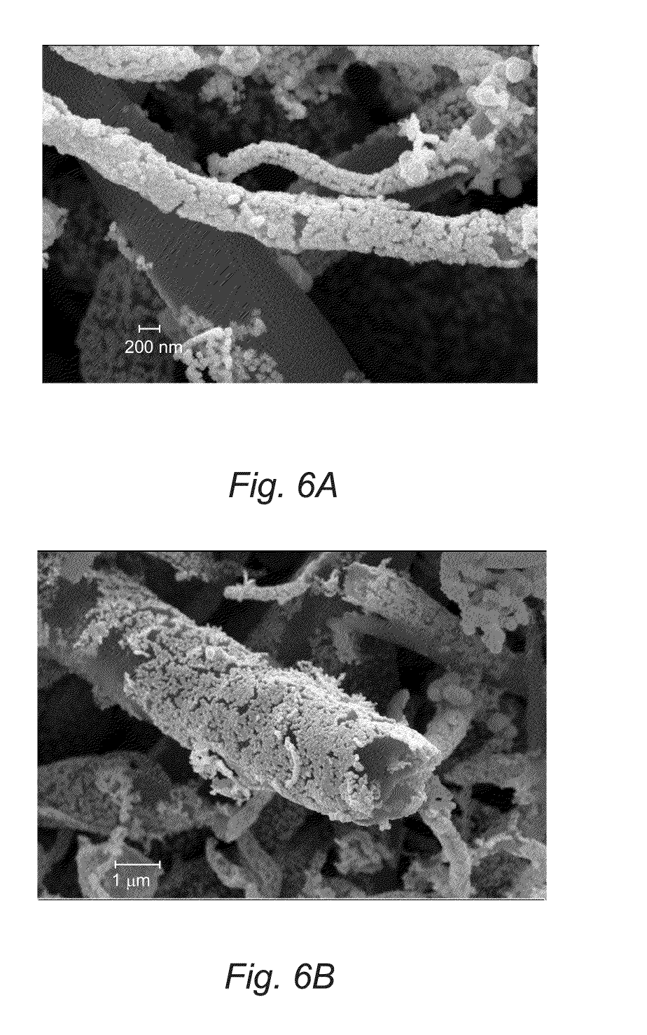

A catalytic layer is added to the sulfonated nanofibers. In the following example, platinum salt is reduced to metallic platinum on the surface of the PPS-S fibers. Poly(phenylene sulfide) nanofibers (1 g), previously modified with the addition of sulfonic acid groups in 0.1 N sodium hydroxide (100 mL) are treated with diaminedinitroplatinum(II) as a 3.4 wt. % solution in dilute ammonium hydroxide [Aldrich, 47.4 mL solution, 48.42 g solution, 1.646 g diaminedinitroplatinum(II), 0.005126 mol diaminedinitroplatinum(II)]. To this mixture is added 100 mL of 15 wt. % sodium borohydride (Aldrich) in 0.1 N sodium hydroxide. After heating at 60° C. for 4 hours with stirring, the mixture is allowed to stir for 16 h at 23° C. The black nanofibers are isolated by filtration, washed with 1 N HCl, washed with isopropanol, and air dried. These metalized nanofibers are useful as fuel cell catalysts (and as electron conducting media in fuel cells). FIGS. 6A and 6B provide micrographs of metalized poly(phenylene sulfide) nanofibers at two different magnifications.

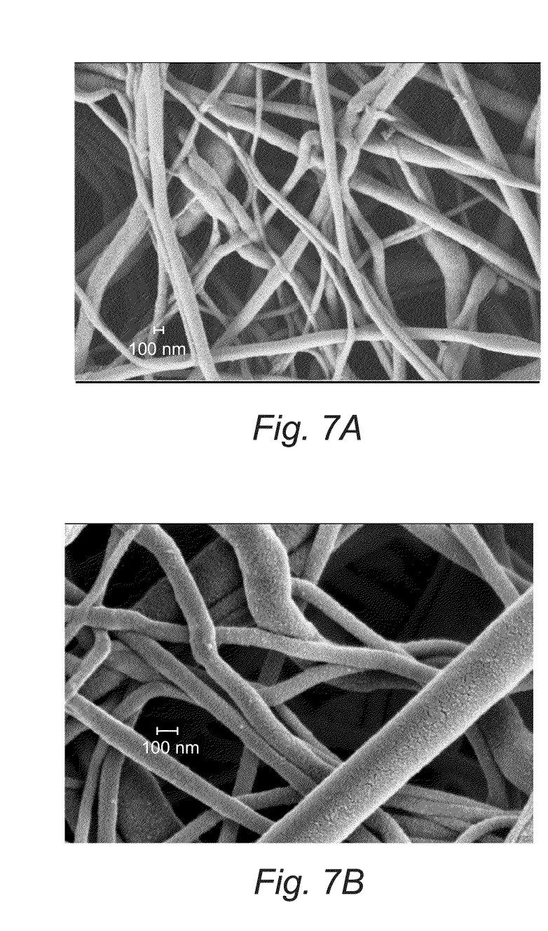

FIGS. 7A and 7B provide micrographs of metalized poly(phenylene sulfide) nanofibers at two different magnifications. In these figures, the metalized poly(phenylene sulfide) nanofibers are coated with gold-palladium by sputter coating.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method comprising:
combining a polyphenylene sulfide-containing resin with a water soluble carrier resin to form a resinous mixture;
shaping the resinous mixture to form a shaped resinous mixture, the shaped resinous mixture having polyphenylene sulfide-containing structures within the carrier resin;
contacting the shaped resinous mixture with water to separate the polyphenylene sulfide-containing structures from the carrier resin;
optionally adding protogenic groups to the polyphenylene sulfide-containing structures; and
adding a catalyst to the polyphenylene sulfide-containing structures.

2. The method of claim 1 further comprising incorporating the polyphenylene sulfide-containing structures into a fuel cell electrode layer.

3. The method of claim 1 wherein the polyphenylene sulfide-containing structures include a component selected from the group consisting of fibers, beads, spheres, and oblong shapes.

4. The method of claim 1 wherein the protogenic groups are SO₂X, —PO₃H₂, or —COX where X is an —OH, a halogen, or an ester.

5. The method of claim 1 wherein the polyphenylene sulfide-containing resin includes a plurality of electrically conductive particles.

6. The method of claim 5 wherein the electrically conductive particles are selected from the group consisting of carbon particles, graphite particles, metal particles, and combinations thereof.

7. The method of claim 1 wherein the carrier resin is a water-soluble polyamide.

8. The method of claim 1 wherein the carrier resin comprises poly(2-ethyl-2-oxazoline).

9. The method of claim 1 wherein the weight ratio of polyphenylene sulfide-containing resin to carrier resin is from about 1:100 to about 10:1.

10. The method of claim 1 wherein the polyphenylene sulfide-containing structures have an average diameter from about 5 nanometers to about 10 microns.

11. The method of claim 1 wherein the catalyst includes a component selected from the group consisting of gold, platinum, palladium, and combinations thereof.

12. A method comprising:
combining a polyphenylene sulfide-containing resin with a water soluble carrier resin to form a resinous mixture;
extruding the resinous mixture to form an extruded resinous mixture, the extruded resinous mixture having polyphenylene sulfide-containing fibers within the carrier resin;
contacting the extruded resinous mixture with water to separate the polyphenylene sulfide-containing fibers from the carrier resin;
sulfonating the polyphenylene sulfide-containing fibers;
coating at least a portion of the polyphenylene sulfide-containing fibers with a catalyst; and
forming the polyphenylene sulfide-containing fibers into a fuel cell electrode layer.

13. The method of claim 12 wherein the polyphenylene sulfide-containing resin includes a plurality of electrically conductive particles.

14. The method of claim 13 wherein the electrically conductive particles are selected from the group consisting of carbon particles, graphite particles, metal particles, and combinations thereof.

15. The method of claim 13 wherein the carrier resin is a water-soluble polyamide.

16. The method of claim 12 wherein the carrier resin comprises poly(2-ethyl-2-oxazoline).

17. A fuel cell comprising:
a first flow field plate;
a second flow field plate;
a first catalyst-containing electrode layer interposed between the first flow field plate and the second flow field plate;
a second catalyst-containing electrode layer interposed between the first flow field plate and the second flow field plate; and
an ion-conducting layer interposed between the first catalyst layer and the second catalyst layer, wherein at least one of the first catalyst-containing electrode layer and the second catalyst-containing electrode layer includes sulfonated polyphenylene sulfide-containing fibers, the sulfonated polyphenylene sulfide-containing fibers including a catalyst.

18. The fuel cell of claim 17 wherein the polyphenylene sulfide-containing fibers include a plurality of electrically conductive particles.

19. The fuel cell of claim 12 wherein the polyphenylene sulfide-containing fibers have an average diameter from about 5 nanometers to about 10 microns.

20. The fuel cell of claim 12 wherein the catalyst includes a component selected from the group consisting of gold, platinum, palladium, and combinations thereof.
